(19) United States
(12) Patent Application Publication
(10) Pub. No.: US 2021/0029345 A1
(43) Pub. Date: Jan. 28, 2021

(54) METHOD OF GENERATING THREE-DIMENSIONAL MODEL, DEVICE FOR GENERATING THREE-DIMENSIONAL MODEL, AND STORAGE MEDIUM

(71) Applicant: Panasonic Intellectual Property Management Co.,Ltd., Osaka (JP)

(72) Inventors: Toru MATSUNOBU, Osaka (JP); Toshiyasu SUGIO, Osaka (JP); Satoshi YOSHIKAWA, Hyogo (JP); Tatsuya KOYAMA, Kyoto (JP); Masaki FUKUDA, Osaka (JP)

(21) Appl. No.: 17/071,431

(22) Filed: Oct. 15, 2020

Related U.S. Application Data
(63) Continuation of application No. PCT/JP2019/020394, filed on May 23, 2019.

(30) Foreign Application Priority Data
May 23, 2018 (JP) 2018-099013

(51) Int. Cl. H04N 13/239; H04N 13/25; H04N 13/246; G06T 7/174; G06T 7/80

(52) U.S. Cl. CPC H04N 13/239; H04N 13/25; G06T 2200/08; G06T 7/174; G06T 7/85; H04N 13/246

(57) ABSTRACT

A method of generating a three-dimensional model includes: calculating camera parameters of n cameras based on m first images, the m first images being captured from m different viewpoints by the n cameras, n being an integer greater than one, m being an integer greater than n; and generating the three-dimensional model based on n second images and the camera parameters, the n second images being captured from n different viewpoints by the n cameras, respectively.

### CROSS REFERENCE TO RELATED APPLICATIONS

This application is a U.S. continuation application of PCT International Patent Application Number PCT/JP2019/020394 filed on May 23, 2019, claiming the benefit of priority of Japanese Patent Application Number 2018-099013 filed on May 23, 2018, the entire contents of which are hereby incorporated by reference.

### BACKGROUND

### 1. Technical Field

The present disclosure relates to a method of generating a three-dimensional model, and a device for generating a three-dimensional model based on a plurality of images obtained by a plurality of cameras, and a storage medium.

### 2. Description of the Related Art

In a three-dimensional reconstruction technique of generating a three-dimensional model in the field of computer vision, a plurality of two-dimensional images are associated with each other to estimate the position(s) or orientation(s) of one or more cameras, and the three-dimensional position of an object. In addition, camera calibration and three-dimensional point cloud reconstruction are performed. For example, such a three-dimensional reconstruction technique is used as a free viewpoint video generation method.

A device described in Japanese Unexamined Patent Application Publication No. 2010-250452 performs calibration among three or more cameras, and converts camera coordinate systems into a virtual camera coordinate system in any viewpoint based on obtained camera parameters. In the virtual camera coordinate system, this device associates images after the coordinate conversion with each other by block matching to estimate distance information. This device synthesizes an image in a virtual camera view based on the estimated distance information.

### SUMMARY

In such a method of generating a three-dimensional model and a device for generating a three-dimensional model an improvement in the accuracy of the three-dimensional model It is thus an objective of the present disclosure to provide a method of generating a three-dimensional model and a device for generating a three-dimensional model at a higher accuracy In order to achieve the objective, a method of generating a three-dimensional model according to one aspect of the present disclosure includes: calculating camera parameters of n cameras based on m first images, the m first images being captured from m different viewpoints by the n cameras, n being an integer greater than one, m being an integer greater than n; and generating the three-dimensional model based on n second images and the camera parameters, the n second images being captured from n different viewpoints by the n cameras, respectively.

The method and the device according to the present disclosure generate a three-dimensional model at a higher accuracy.

### BRIEF DESCRIPTION OF DRAWINGS

These and other objects, advantages and features of the disclosure will become apparent from the following description thereof taken in conjunction with the accompanying drawings that illustrate a specific embodiment of the present disclosure.

FIG. 1 shows an outline of a free viewpoint video generation system according to an embodiment;

FIG. 2 illustrates three-dimensional reconstruction according to the embodiment;

FIG. 3 illustrates synchronous imaging according to the embodiment;

FIG. 4 illustrates the synchronous imaging according to the embodiment;

FIG. 5 is a block diagram of a free viewpoint video generation system according to the embodiment;

FIG. 6 is a flowchart showing processing by the free viewpoint video generation device according to the embodiment;

FIG. 7 shows an example multi-viewpoint frameset according to the embodiment;

FIG. 8 is a block diagram showing a structure of a free viewpoint video generator according to the embodiment;

FIG. 9 is a flowchart showing an operation of the free viewpoint video generator according to the embodiment;

FIG. 10 is a block diagram showing a structure of a free viewpoint video generator according to Variation 1;

FIG. 11 is a flowchart showing an operation of the free viewpoint video generator according to Variation 1; and

FIG. 12 shows an outline of a free viewpoint video generation system according to Variation 2.

### DETAILED DESCRIPTION OF THE EMBODIMENT

### Underlying Knowledge Forming Basis of the Present Disclosure

Generation of free viewpoint videos includes three stages of processing of camera calibration, three-dimensional modeling, and free viewpoint video generation. The camera calibration is processing of calibrating camera parameters of each of a plurality of cameras. The three-dimensional modeling is processing of generating a three-dimensional model based on the camera parameters and a plurality of images obtained by the plurality of cameras. The free viewpoint video generation is processing of generating a free viewpoint video based on the three-dimensional model and the plurality of images obtained by the plurality of cameras.

In these three stages of processing, a larger number of viewpoints, that is, a larger number of images causes the trade-off between a higher processing load and an improved accuracy. In the three stages of processing, influencing the three-dimensional modeling and the free viewpoint video generation, the camera calibration requires the highest accuracy. For example, whether all of the images captured by the cameras, such as two adjacent cameras, in positions closer to each other or one of the images are/is used does not influence the accuracy in the free viewpoint video generation. From these facts, the present inventors found that the numbers of viewpoints of images, that is, the numbers of positions in which the image is captured, suitable for these three stages of processing were different from each other.

Lacking this idea of using images in different numbers of viewpoints among the three stages of processing, the background art such as Japanese Unexamined Patent Application Publication No. 2010-250452 may fail to exhibit sufficient accuracy of the three-dimensional model. In addition, the background art may fail to sufficiently reduce the processing load required for generating the three-dimensional model.

To address the problems, the present disclosure provides a method of generating a three-dimensional model and a device for generating a three-dimensional model at a higher accuracy, which will now be described.

A method of generating a three-dimensional model includes: calculating camera parameters of n cameras based on m first images, the m first images being captured from m different viewpoints by the n cameras, n being an integer greater than one, m being an integer greater than n; and generating the three-dimensional model based on n second images and the camera parameters, the n second images being captured from n different viewpoints by the n cameras, respectively.

In this way, in this method of generating a three-dimensional model, in order to improve the accuracy of the camera parameters, the number m is determined as the number of viewpoints for a multi-viewpoint frameset used in the calculating. The number m is larger than the number n of viewpoints in the generating of the three-dimensional model. This feature improves the accuracy in the generating of the three-dimensional model.

The method may further include: generating a free viewpoint video based on (1) 1 third images respectively captured by 1 cameras included in the n cameras, where 1 is an integer greater than or equal to two and less than n, (2) the camera parameters calculated in the calculating, and (3) the three-dimensional model generated in the generating of the three-dimensional model.

In this way, the number 1 is determined as the number of viewpoints for a multi-viewpoint frameset used in the free viewpoint video generation. The number 1 is smaller than the number n of viewpoints in the generating of the three-dimensional model. This feature reduces a decrease in the accuracy in the processing of generating the free viewpoint video, and reduces the processing load required to generate the free viewpoint video.

In the calculating, (1) first camera parameters that are camera parameters of a plurality of cameras including the n cameras and the additional camera may be calculated based on the m first images captured by the plurality of cameras, and (2) second camera parameters that are the camera parameters of the n cameras may be calculated based on the first camera parameters and n fourth images respectively captured by the n cameras. In the generating of the three-dimensional model, the three-dimensional model may be generated based on the n second images and the second camera parameters.

In this way, the camera calibration is executed in the two stages, which improves the accuracy of the camera parameter.

The n cameras may include i first cameras that perform imaging with a first sensitivity, and j second cameras that perform imaging with a second sensitivity that is different from the first sensitivity. In the generating of the three-dimensional model, the three-dimensional model may be generated based on the n second images captured by all the n cameras. In the generating of the free viewpoint video, the free viewpoint video may be generated based on the camera parameters, the three-dimensional model, and the 1 third images that are captured by the i first cameras or the j second cameras.

In this way, the free viewpoint video generation is performed based on one of the two types of images obtained by the two types of cameras with different sensitivities, depending on the conditions of the space to be imaged. This configuration allows accurate generation of the free viewpoint video.

The i first cameras and the j second cameras may have color sensitivities different from each other.

In this way, the free viewpoint video generation is performed based on one of the two types of images obtained by the two types of cameras with different color sensitivities, depending on the conditions of the space to be imaged. This configuration allows accurate generation of the free viewpoint video.

The i first cameras and the j second cameras may have brightness sensitivities different from each other.

In this way, the free viewpoint video generation is performed based on one of the two types of images obtained by the two types of cameras with different brightness sensitivities, depending on the conditions of the space to be imaged. This allows accurate generation of the free viewpoint video.

The n cameras may be fixed cameras fixed in positions and orientations different from each other. The additional camera may be an unfixed camera that is not fixed.

The m first images used in the calculating may include images captured at different times. The n second images used in the generating of the three-dimensional model may be images captured by the n cameras at a first time.

Note that these general or specific aspects may be implemented using a system, a device, an integrated circuit, a computer program, or a storage medium such as a computer-readable CD-ROM or any combination of systems, devices, integrated circuits, computer programs, and storage media.

Now, an embodiment will be described in detail with reference to the drawings. Note that the embodiment described below is a mere specific example of the present disclosure. The numerical values, shapes, materials, constituent elements, the arrangement and connection of the constituent elements, steps, step orders etc. shown in the following embodiment are thus mere examples, and are not intended to limit the scope of the present disclosure. Among the constituent elements in the following embodiment, those not recited in any of the independent claims defining the broadest concept of the present disclosure are described as optional constituent elements.

### Embodiment

A device for generating a three-dimensional model according to this embodiment generates a time-series three-dimensional model whose coordinate axes are consistent over time. Specifically, first, the device independently performs three-dimensional reconstruction at each time to obtain a three-dimensional model at each time. Next, the device detects a still camera and a stationary object (i.e., three-dimensional stationary points), matches the coordinates of the three-dimensional models among the times using the detected still camera and stationary object. The device then generates the time-series three-dimensional model with the consistent coordinate axes.

This configuration allows the device to generate the time-series three-dimensional model. The model achieves a highly accurate relative positional relationship between an object and a camera regardless of whether the camera if fixed or unfixed or whether the object is static or moving. Transition information in the time direction is available for the model.

The free viewpoint video generation device applies, to the generated time-series three-dimensional model, texture information obtainable from an image captured by a camera, to generate a free viewpoint video when the object is seen from any viewpoint.

Note that the free viewpoint video generation device may include the device for generating a three-dimensional model. Similarly, the free viewpoint video generation method may include a method of generating a three-dimensional model.

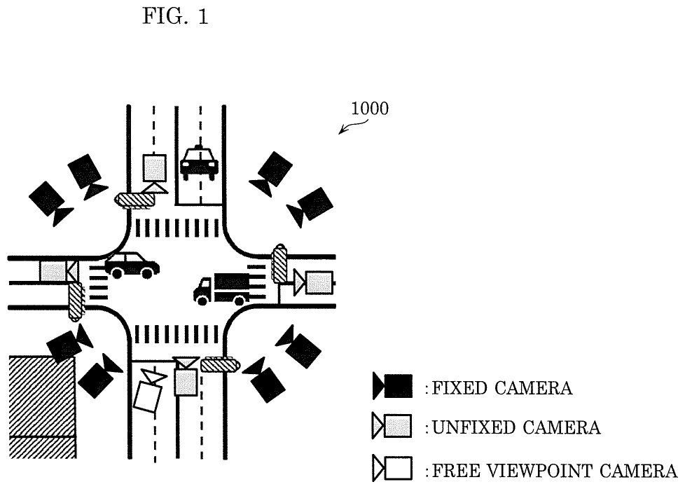

FIG. 1 shows an outline of a free viewpoint video generation system. For example, a single space is captured from multiple viewpoints using calibrated cameras (e.g., fixed cameras) so as to be reconstructed three-dimensionally (i.e., subjected to three-dimensional spatial reconstruction). Using this three-dimensionally reconstructed data, tracking, scene analysis, and video rendering can be performed to generate a video from any viewpoint (i.e., a free viewpoint camera). Accordingly, a next-generation wide-area monitoring system and a free viewpoint video generation system can be achieved.

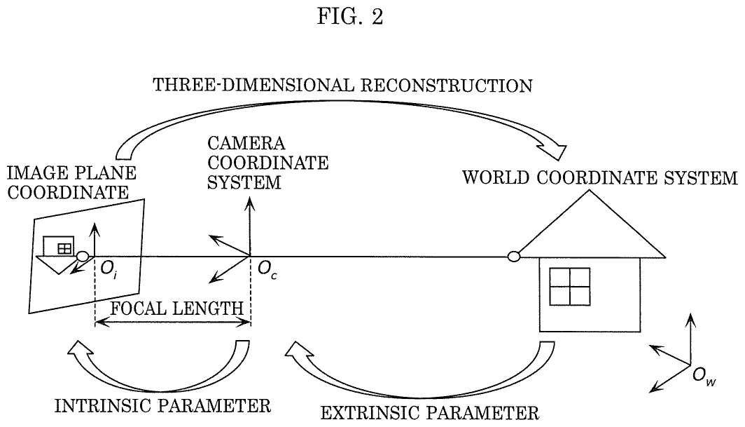

Now, the three-dimensional reconstruction according to the present disclosure will be defined. Videos or images, of an object present in an actual space, captured in different viewpoints by a plurality of cameras are referred to as “videos from multiple viewpoints” or “images from multi-viewpoints”. That is, that “images from multi-viewpoints” include a plurality of two-dimensional images of a single object captured from different viewpoints. In particular, the images from multiple viewpoints captured in a chronological order are referred to as “videos from multiple viewpoints”. Reconstruction of an object into a three-dimensional space based on these images from multiple viewpoints is referred to as “three-dimensional reconstruction”. FIG. 2 shows a mechanism of the three-dimensional reconstruction.

The free viewpoint video generation device reconstructs points on an image plane in a world coordinate system based on camera parameters. An object reconstructed in a three-dimensional space is referred to as a “three-dimensional model”. The three-dimensional model of an object shows the three-dimensional positions of each of a plurality of points on the object included in two-dimensional images in multiple viewpoints. The three-dimensional positions are represented, for example, by ternary information including an X-component, a Y-component, and a Z-component of a three-dimensional coordinate space composed of X-, Y-, and Z-axes. Note that the three-dimensional model may include not only the three-dimensional positions but also information representing the colors of the points as well as the surface profile of the points and the surroundings.

At this time, the free viewpoint video generation device may obtain the camera parameters of cameras in advance or estimate the parameters at the same time as the generation of the three-dimensional models. The camera parameters include intrinsic parameters such as focal lengths and optical centers of cameras, and extrinsic parameters such as the three-dimensional positions and orientations of the cameras.

FIG. 2 shows an example of a typical pinhole camera model. In this model, the lens distortion of the camera is not taken into consideration. If lens distortion is taken into consideration, the free viewpoint video generation device employs corrected positions obtained by normalizing the positions of the points on an image plane coordinate by a distortion model.

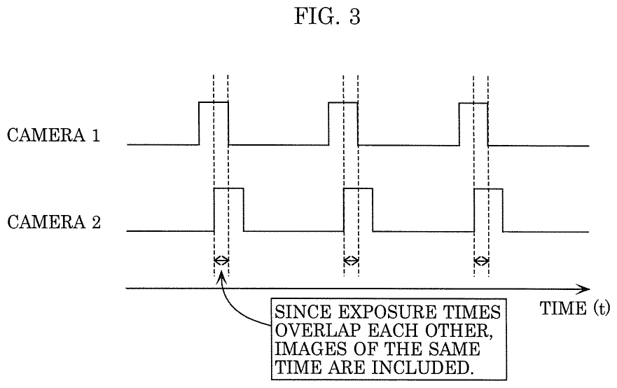

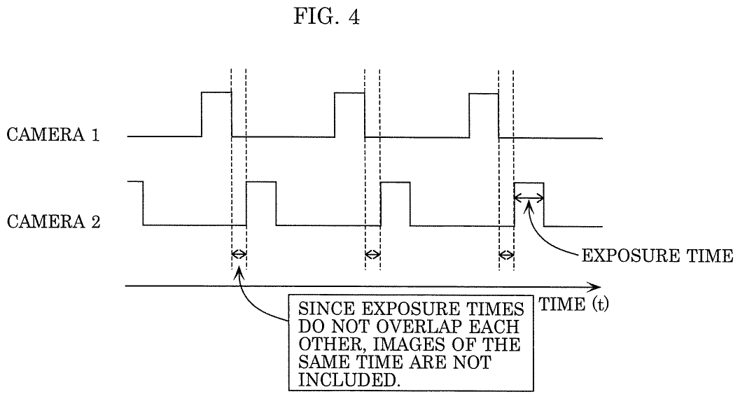

Next, synchronous imaging of videos from multiple viewpoints will be described. FIGS. 3 and 4 illustrate synchronous imaging. In FIGS. 3 and 4, the horizontal axis represents time. A rise of a square wave signal indicates that a camera is exposed to light. When obtaining an image using a camera, the time when a shutter is open is referred to as an “exposure time”.

During an exposure time, a scene exposed to an image sensor through a lens is obtained as an image. In FIG. 3, exposure times overlap with each other between the frames captured by two cameras in different viewpoints. Accordingly, the frames obtained by the two cameras are determined as “synchronous frames” containing a scene of the same time.

On the other hand, in FIG. 4, there is no overlap between the exposure times of two cameras. The frames obtained by the two cameras are thus determined as “asynchronous frames” containing no scene of the same time. As shown in FIG. 3, capturing synchronous frames with a plurality of cameras is referred to as “synchronous imaging”.

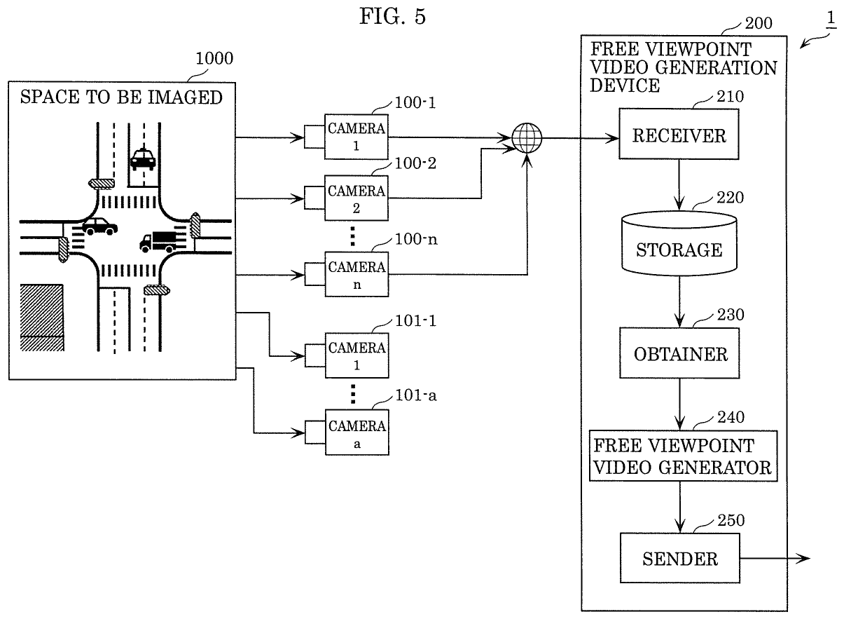

Next, a configuration of the free viewpoint video generation system according to this embodiment will be described. FIG. 5 is a block diagram of the free viewpoint video generation system according to this embodiment. Free viewpoint video generation system 1 shown in FIG. 5 includes a plurality of cameras 100-1 to 100-n and 101-1 to 101-a and free viewpoint video generation device 200.

The plurality of cameras 100-1 to 100-n and 101-1 to 101-a image an object and output videos from multiple viewpoints that are the plurality of captured videos. The videos from multiple viewpoints may be sent via a public communication network such as the internet or a dedicated communication network. Alternatively, the videos from the multiple viewpoints may be stored once in an external storage device such as a hard disk drive (HDD) or a solid-state drive (SSD) and input to free viewpoint video generation device 200 when necessary. Alternatively, the videos from the multiple viewpoints may be sent once via a network to an external storage device such as a cloud server and stored in the storage device. The videos from the multiple viewpoints may be sent to free viewpoint video generation device 200 when necessary.

N cameras 100-1 to 100-n are fixed cameras such as monitoring cameras. That is, n cameras 100-1 to 100-n are, for example, fixed cameras that are fixed in positions and orientations different from each other. A cameras 101-1 to 101-a, that is, the cameras of the plurality of cameras 100-1 to 100-n and 101-1 to 101-a other than n cameras 100-1 to 100-n are unfixed camera that are not fixed. A cameras 101-1 to 101-a may be, for example, mobile cameras such as video cameras, smartphones, or wearable cameras or may be moving cameras such as drones with an imaging function. A cameras 101-1 to 101-a are mere examples of the additional camera. Note that n is an integer of two or more. On the other hand, a is an integer of one or more.

As header information on a video or a frame, camera identification information such as a camera ID number for identifying a camera that has captured the video or the frame may be added to each of the videos from the multiple viewpoints.

With the use of the plurality of cameras 100-1 to 100-n and 101-1 to 101-a, synchronous imaging is performed which images an object into frames of the same time. Alternatively, the times indicated by timers built in the plurality of cameras 100-1 to 100-n and 101-1 to 101-a may be synchronized and imaging time information or index numbers indicating the order of imaging may be added to videos or frames, without performing the synchronous imaging.

As the header information, information indicating whether the synchronous imaging or the asynchronous imaging is performed may be added to each video set, video, or frame of the videos from the multiple viewpoints.

Free viewpoint video generation device 200 includes, receiver 210, storage 220, obtainer 230, free viewpoint video generator 240, and sender 250.

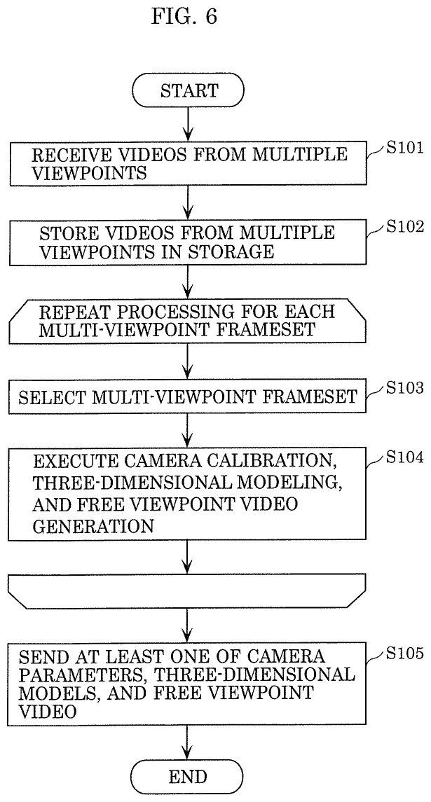

Next, an operation of free viewpoint video generation device 200 will be described. FIG. 6 is a flowchart showing an operation of free viewpoint video generation device 200 according to this embodiment.

First, receiver 210 receives the videos from the multiple viewpoints captured by the plurality of cameras 100-1 to 100-n and 101-1 to 101-a (S101). Storage 220 stores the received videos from the multiple viewpoints (S102).

Next, obtainer 230 select frames from the videos from the multiple viewpoints and outputs the selected frames as a multi-viewpoint frameset to free viewpoint video generator 240 (S103).

For example, the multi-viewpoint frameset may be composed of a plurality of frames, each selected from one of the videos in all the viewpoints, or may include at least the frames, each selected from one of the videos in all the viewpoints. Alternatively, the multi-viewpoint frameset may be composed of a plurality of frames, each selected from one of videos in two or more viewpoints selected from the multiple viewpoints, or may include at least the frames, each selected from one of videos in two or more viewpoints selected from the multiple viewpoints.

Assume that no camera identification information is added to each frame of the multi-viewpoint frameset. In this case, obtainer 230 may individually add the camera identification information to the header information on each frame or may collectively add the camera identification information to the header information on the multi-viewpoint frameset.

Assume that no index number indicating the imaging time or the order of imaging/is added to each frame of the multi-viewpoint frameset. In this case, obtainer 230 may individually add the imaging time or the index number to the header information on each frame, or may collectively add imaging times or index numbers to the header information on the frameset.

Next, free viewpoint video generator 240 executes the camera calibration, the three-dimensional modeling, and the free viewpoint video generation, based on the multi-viewpoint frameset, to generate the free viewpoint video (S104).

The processing in steps S103 and S104 is repeated for each multi-viewpoint frameset.

Lastly, sender 250 sends at least one of the camera parameters, the three-dimensional model of an object, and the free viewpoint video to an external device (S105).

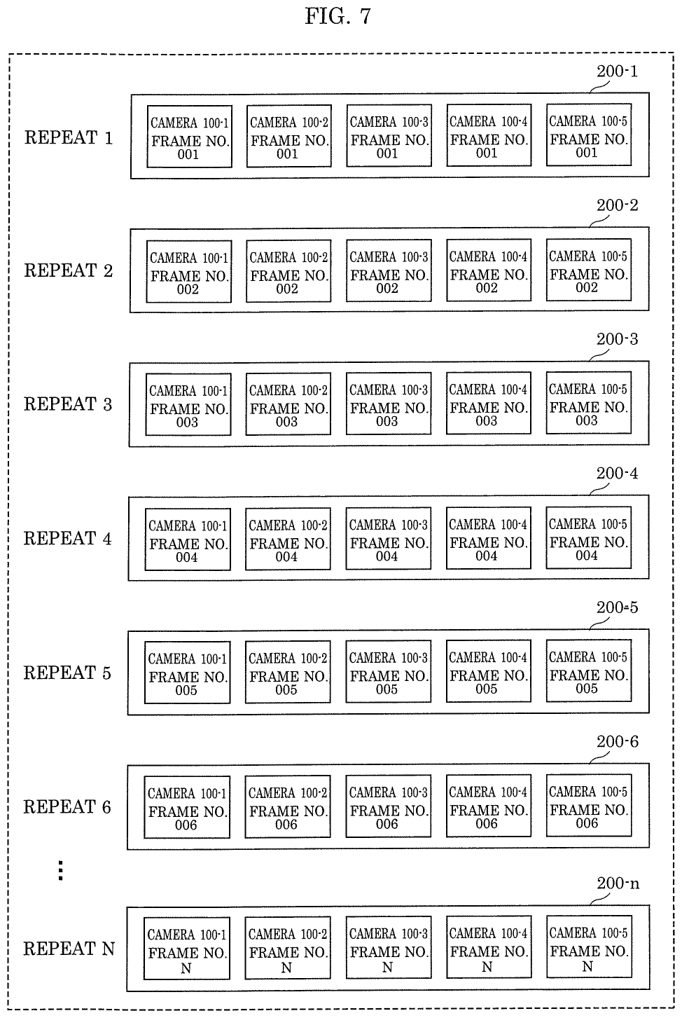

Next, details of a multi-viewpoint frameset will be described. FIG. 7 shows an example multi-viewpoint frameset. In this embodiment, an example will be described where obtainer 230 selects one frame from each of five cameras 100-1 to 100-5 to determine a multi-viewpoint frameset.

The example assumes that the plurality of cameras perform the synchronous imaging. Each of camera ID numbers 100-1 to 100-5 for identifying a camera that has captured a frame is added to the header information on the frame. Each of frame numbers 001 to N indicating the order of imaging among the cameras is added to the header information on a frame. Frames, with the same frame number, of the cameras include an object captured by the cameras at the same time.

Obtainer 230 sequentially outputs multi-viewpoint framesets 200-1 to 200-n to free viewpoint video generator 240. Free viewpoint video generator 240 performs repeat to sequentially perform three-dimensional reconstruction based on multi-viewpoint framesets 200-1 to 200-n.

Multi-viewpoint frameset 200-1 is composed of five frames of frame number 001 of camera 100-1, frame number 001 of camera 100-2, frame number 001 of camera 100-3, frame number 001 of camera 100-4, and frame number 001 of camera 100-5. Free viewpoint video generator 240 uses this multi-viewpoint frameset 200-1 as a first set of the frames of the videos from the multiple viewpoints in repeat 1 to reconstruct the three-dimensional model as of the time of capturing the frames with frame number 001.

With respect to multi-viewpoint frameset 200-2, all the cameras update the frame number. Multi-viewpoint frameset 200-2 is composed of five frames of frame number 002 of camera 100-1, frame number 002 of camera 100-2, frame number 002 of camera 100-3, frame number 002 of camera 100-4, and frame number 002 of camera 100-5. Free viewpoint video generator 240 uses multi-viewpoint frameset 200-2 in repeat 2 to reconstruct the three-dimensional model as of the time of capturing the frames with frame number 002.

Similarly, in repeat 3 and subsequent repeats, all the cameras update the frame number. This configuration allows free viewpoint video generator 240 to reconstruct the three-dimensional models at the respective times.

Since the three-dimensional reconstruction is performed independently at each time, the coordinate axes and scales of the plurality of reconstructed three-dimensional models are not always consistent. That is, in order to obtain the three-dimensional model of a moving object, the coordinate axes and scales at respective times need to be matched.

In this case, the imaging times are added to the frames. Based on the imaging times, obtainer 230 creates a multi-viewpoint frameset that is a combination of synchronous frames and asynchronous frames. Now, a method of determining synchronous frames and asynchronous frames using the imaging times of two cameras will be described.

Assume that T1 is the imaging time of a frame selected from camera 100-1, T2 is the imaging time of a frame selected from camera 100-2, TE1 is an exposure time of camera 100-1, and TE2 is an exposure time of camera 100-2. Imaging times T1 and T2 here represent the times when exposure starts, that is, the rising edges of the square wave signal in the examples of FIGS. 3 and 4.

In this case, the exposure of camera 100-1 ends at time T1+TE1. At this time, satisfaction of the expressions (1) or (2) means that the two cameras capture the object of the same time, and the two frames are determined as the synchronous frames.

T1≤T2≤T1+TE1 (1)

T1≤T2+TE2≤T1+TE1 (2)

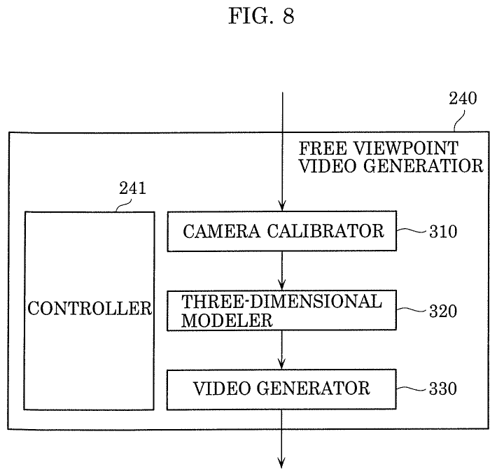

Next, details of free viewpoint video generator 240 will be described. FIG. 8 is a block diagram showing a structure of free viewpoint video generator 240. As shown in FIG. 8, free viewpoint video generator 240 includes controller 241, camera calibrator 310, three-dimensional modeler 320, and video generator 330.

Controller 241 determines the numbers of viewpoints suitable for the processing of camera calibrator 310, three-dimensional modeler 320, and video generator 330. The numbers of viewpoints determined here are different from each other.

Controller 241 determines the number of viewpoints for a multi-viewpoint frameset used in the three-dimensional modeling by three-dimensional modeler 320, for example, to be the same, that is n, as the number of n cameras 100-1 to 100-n that are the fixed cameras. Controller 241 determines then, using the number n of viewpoints used in the three-dimensional modeling as a reference, the numbers of viewpoints for the multi-viewpoint frameset used in the camera calibration and the free viewpoint video generation that are the other processing.

The accuracy of the camera parameters calculated in the camera calibration largely influences the accuracy in the three-dimensional modeling and the free viewpoint video generation. That is, controller 241 determines, as the number of viewpoints for a multi-viewpoint frameset used in the camera calibration, the number m of viewpoints that is larger than the number n of viewpoints used in the three-dimensional modeling. This is to not reduce the accuracy in the three-dimensional modeling and the free viewpoint video generation and improve the accuracy of the camera parameters. That is, controller 241 causes camera calibrator 310 to execute the camera calibration based on m frames. The m frames include the n frames captured by n cameras 100-1 to 100-n and, in addition, k frames, where k is an integer of a or more, captured by a cameras 101-1 to 101-a. Note that the number of a cameras 101-1 to 101-a is not necessarily k. Instead, k frames (or images) may be obtained as a result of imaging ink viewpoints with a cameras 101-1 to 101-a moving.

In calculation of the corresponding positions between an image obtained by an actual camera and an image in a virtual viewpoint in the free viewpoint video generation, a larger number of actual cameras require a higher processing load and thus a longer processing time. On the other hand, among a plurality of images obtained by a plurality of cameras in closer positions, out of n cameras 100-1 to 100-n, texture information obtainable from the images are similar to each other. Accordingly, whether one or all the images is/are used does not largely influence the accuracy in a result of the free viewpoint video generation. Controller 241 thus determines the number 1 as the number of viewpoints for a multi-viewpoint frameset used in the free viewpoint video generation. The number 1 is smaller than the number n of viewpoints in the three-dimensional modeling.

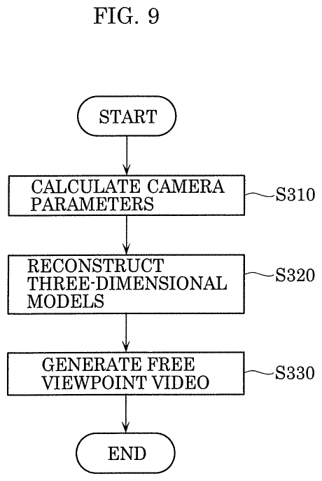

FIG. 9 is a flowchart showing an operation of free viewpoint video generator 240. Note that the multi-viewpoint frameset in the number of viewpoints determined by controller 241 is used in the processing shown in FIG. 9.

First, camera calibrator 310 calculates the camera parameters of the plurality of cameras 100-1 to 100-n and 101-1 to 101-a based on m first images captured in the m different viewpoints by the plurality of cameras 100-1 to 100-n and 101-1 to 101-a (S310). The n cameras 100-1 to 100-n are located in the positions different from each other. Note that the m viewpoints here are based on the number of viewpoints determined by controller 241.

Specifically, camera calibrator 310 calculates, as the camera parameters, the intrinsic parameters, extrinsic parameters, and lens distortion coefficients of cameras 100-1 to 100-n and 101-1 to 101-a. The intrinsic parameters indicate optical characteristics, such as focal lengths, aberrations, and optical centers, of the cameras. The extrinsic parameters indicate the positions and orientations of the cameras in a three-dimensional space.

Camera calibrator 310 may independently calculate the intrinsic parameters, the extrinsic parameters, and the lens distortion coefficients based on the m first images that are m frames captured at the intersections between the black and white squares of a checkerboard by the plurality of cameras 100-1 to 100-n. Alternatively, the camera calibrator may collectively calculate the intrinsic parameters, the extrinsic parameters, and the lens distortion coefficients using corresponding points among the m frames as in structure from motion to perform overall optimization. In the latter case, the m frames are not necessarily the images including the checkerboard.

Note that camera calibrator 310 performs the camera calibration based on the m first images obtained by n cameras 100-1 to 100-n that are the fixed cameras and a cameras 101-1 to 101-a that are the unfixed cameras. In the camera calibration, a larger number of the cameras causes longer intervals between the cameras, that is, cameras close to each other have views closer to each other. It is thus easy to associate the images obtainable from the cameras close to each other. For the purpose, at the time of camera calibration, camera calibrator 310 increases the number of viewpoints using a cameras 101-1 to 101-a that are the unfixed cameras in addition to n cameras 100-1 to 100-n that are the fixed cameras always placed in space 1000 to be imaged.

At least one moving camera may be used as an unfixed camera. When a moving camera is used as an unfixed camera, images at different imaging times are included. That is, the m first images used in the camera calibration include the images captured at different times. In other words, a multi-viewpoint frameset composed of the m first images in the m viewpoints includes a frame obtained by the asynchronous imaging. Camera calibrator 310 performs thus the camera calibration utilizing the matching points between the images of the feature points obtainable from the still areas of the m first images including stationary objects. Accordingly, camera calibrator 310 calculates the camera parameters associated with the still areas. The still areas are the areas of the m first images other than moving areas including moving objects. The moving areas included in the frames are detected, for example, by calculating the differences from the previous frames or by calculating the differences from background videos, or automatically detecting the areas with a moving object through machine learning.

Note that camera calibrator 310 may not always perform the camera calibration of step S310 in the free viewpoint video generation by free viewpoint video generator 240 and may perform the camera calibration once in a predetermined time.

Next, three-dimensional modeler 320 reconstructs (i.e., generates) the three-dimensional models based on n second images captured by n cameras 100-1 to 100-n and the camera parameters obtained in the camera calibration (S320). That is, three-dimensional modeler 320 reconstructs the three-dimensional models based on the n second images captured in the n viewpoints based on the number n of viewpoints determined by controller 241. Accordingly, three-dimensional modeler 320 reconstructs, as three-dimensional points, an object included in the n second images. The n second images used in the three-dimensional modeling are the images, each captured by one of n cameras 100-1 to 100-n at any time. That is, a multi-viewpoint frameset composed of the n second images in the n viewpoints is obtained by the synchronous imaging. Three-dimensional modeler 320 performs thus the three-dimensional modeling using the areas (i.e., all the areas) of the n second images including the stationary objects and the moving objects. Note that three-dimensional modeler 320 may use results of measurement by a laser scanner measuring the positions of objects in the three-dimensional space or may calculate the positions of objects in the three-dimensional space using the associated points of a plurality of stereo images as in a multi-viewpoint stereo algorithm.

Next, video generator 330 generates the free viewpoint video based on 1 third images, the camera parameters, and the three-dimensional models (S330). Each of the 1 third images is captured by one of 1 of n cameras 100-1 to 100-n. The camera parameters are calculated in the camera calibration. The three-dimensional models are reconstructed in the three-dimensional modeling. That is, video generator 330 generates the free viewpoint video based on the 1 third images captured in the 1 viewpoints based on the number 1 of viewpoints determined by controller 241. Specifically, video generator 330 calculates texture information on the virtual viewpoints using the texture information on the actual cameras based on the corresponding positions. The corresponding positions are, between the images captured by the actual cameras and the images in the virtual viewpoints, obtained based on the camera parameters and the three-dimensional models. The video generator then generates the free viewpoint video.

Free viewpoint video generation device 200 according to this embodiment aims to improve the accuracy of the camera parameters taking the following fact into consideration. The accuracy of the camera parameters calculated in the camera calibration largely influences the accuracy in the three-dimensional modeling and the free viewpoint video generation. For the purpose, the free viewpoint video generation device determines the number m as the number of viewpoints for the multi-viewpoint frameset used in the camera calibration. The number m is larger than the number n of viewpoints in the three-dimensional modeling. Accordingly, the accuracy in the three-dimensional modeling and the free viewpoint video generation improves.

Free viewpoint video generation device 200 according to this embodiment may determine the number 1 as the number of viewpoints for the multi-viewpoint frameset used in the free viewpoint video generation. The number 1 is smaller than the number n of viewpoints in the three-dimensional modeling. Accordingly, the free viewpoint video generation device reduces the processing load required to generate a free viewpoint video.

### Variation 1

Now, a free viewpoint video generation device according to Variation 1 will be described.

The free viewpoint video generation device according to Variation 1 is different from free viewpoint video generation device 200 according to the embodiment in the configuration of free viewpoint video generator 240A. With respect to the other configurations, the free viewpoint video generation device according to Variation 1 is the same as free viewpoint video generation device 200 according to the embodiment. Details description will thus be omitted.

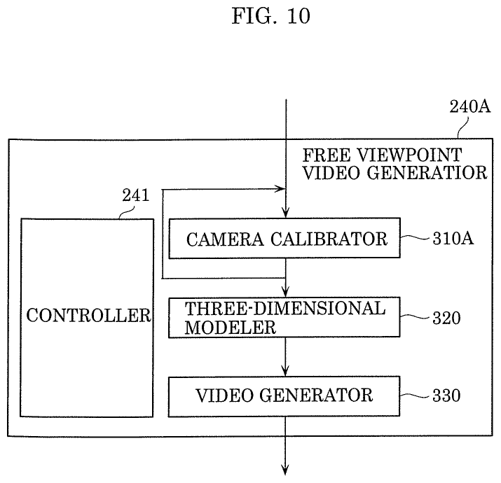

Details of free viewpoint video generator 240A will be described with reference to FIG. 10. FIG. 10 is a block diagram showing a structure of free viewpoint video generator 240A. As shown in FIG. 10, free viewpoint video generator 240A includes controller 241, camera calibrator 310A, three-dimensional modeler 320, and video generator 330. Free viewpoint video generator 240A differs from free viewpoint video generator 240 according to the embodiment in the configuration of camera calibrator 310A. The other configurations are the same. Thus, only camera calibrator 310A will be described below.

As described in the embodiment, the plurality of cameras 100-1 to 100-n and 101-1 to 101-a of free viewpoint video generation system 1 include the unfixed cameras. For this reason, the camera parameters calculated by camera calibrator 310A do not always correspond to the moving areas captured by the fixed cameras. In the format such as the structure from motion, the overall optimization of the camera parameters is performed. Thus, if focusing on the fixed cameras only, the optimization is not always performed successfully. To address the problem, in this variation, camera calibrator 310A executes the camera calibration in two stages of steps S311 and S312 unlike the embodiment.

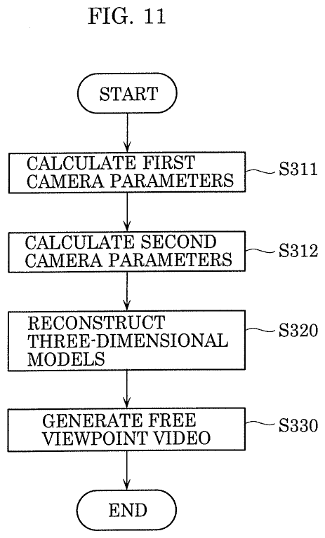

FIG. 11 is a flowchart showing an operation of free viewpoint video generator 240A. Note that the processing shown in FIG. 11 employs a multi-viewpoint frameset in the number of viewpoints determined by controller 241.

Camera calibrator 310A calculates first camera parameters that are camera parameters of the plurality of cameras 100-1 to 100-n and 101-1 to 101-a based on m first images, each captured by one of the plurality of cameras 100-1 to 100-n and 101-1 to 101-a (S311). That is, camera calibrator 310A performs rough camera calibration based on the multi-viewpoint frameset composed of n images and k images. The n images are captured by n cameras 100-1 to 100-n that are fixed cameras always placed in space 1000 to be imaged, whereas the k images are captured by a cameras 101-1 to 101-a that are moving cameras (i.e., unfixed cameras).

Next, camera calibrator 310A calculates second camera parameters that are the camera parameters of n cameras 100-1 to 100-n based on the first camera parameters and n fourth images (S312). Each of the n fourth images is captured by one of n cameras 100-1 to 100-n that are the fixed cameras always placed in space 1000 to be imaged. That is, camera calibrator 310A optimizes the first camera parameters calculated in step S311 under the environment with n cameras 100-1 to 100-n based on the n images captured by n camera. The “optimization” here is the following processing. The three-dimensional points obtained secondarily in the calculation of the camera parameters are reprojected onto the n images. The errors, which are also referred to as “reprojection errors”, between the points, obtained by the reprojection, on the image and the feature points detected on the image are regarded as evaluation values. The evaluation values are minimized.

Three-dimensional modeler 320 reconstructs the three-dimensional models based on the n second images and the second camera parameters calculated in step S312 (S320).

Note that step S330 is the same or similar to that in the embodiment and details description will thus be omitted.

The free viewpoint video generation device according to Variation 1 executes the camera calibration at the two states and thus improves the accuracy of the camera parameters.

### Variation 2

Now, a Free Viewpoint Video Generation Device According to Variation 2 will be described.

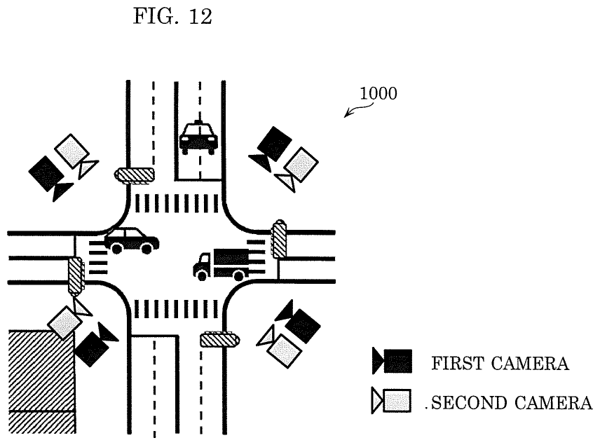

FIG. 12 shows an outline of the free viewpoint video generation system according to Variation 2.

N cameras 100-1 to 100-n in the embodiment and its variation 1 described above may be stereo cameras including two types of cameras. Each stereo camera may include two cameras, namely a first camera and a second camera, that perform imaging in substantially the same direction as shown in FIG. 12. The two cameras may be spaced apart from each other at a predetermined distance or smaller. If n cameras 100-1 to 100-n are such stereo cameras, there are n/2 first cameras and n/2 second cameras. Note that the two cameras included in each stereo camera may be integrated or separated.

The first and second cameras constituting a stereo camera may perform imaging with sensitivities different from each other. The first camera performs imaging with a first sensitivity. The second camera performs imaging with a second sensitivity that is different from the first sensitivity. The first and second cameras have color sensitivities different from each other.

The three-dimensional modeler according to Variation 2 reconstructs the three-dimensional models based on the n second images captured by all of n cameras 100-1 to 100-n. In the three-dimensional modeling, the three-dimensional modeler uses brightness information and thus highly accurately calculates the three-dimensional model using all the n cameras regardless of the color sensitivities.

A video generator according to Variation 2 generates the free viewpoint video based on the following n/2 third images, camera parameters, and three-dimensional models. The n/2 third images are the images captured by the n/2 first cameras or the n/2 second cameras. The camera parameters are calculated by the camera calibrator. The three-dimensional models are reconstructed by the three-dimensional modeler according to Variation 2. The video generator may use the n/2 images captured only by the n/2 first cameras or the n/2 second cameras in the free viewpoint video generation, which less influences the accuracy. In this point of view, the video generator according to Variation 2 performs the free viewpoint generation based on the n/2 images captured by the first cameras or the second cameras depending on the conditions of space 1000 to be imaged. For example, assume that the n/2 first cameras are more sensitive to red colors, whereas the n/2 second cameras are more sensitive to blue colors. In this case, the video generator according to Variation 2 switches the images for use to execute the free viewpoint video generation. The video generator uses the images captured by the first cameras, which are more sensitive to red colors, if the object is in a red color. The video generator uses the images captured by the second cameras, which are more sensitive to blue colors, if the object is in a blue color.

The free viewpoint video device according to Variation 2 performs the free viewpoint video generation based on one of two types of images obtainable by two types of cameras with different sensitivities, depending on the conditions of the space to be imaged. Accordingly, the free viewpoint videos are generated accurately.

Note that the first and second cameras may be not only cameras with different color sensitivities but also cameras with different brightness sensitivities. In this case, the video generator according to Variation 2 may switch cameras depending on the conditions such as daytime or nighttime or sunny or cloudy weather.

While variation 2 has been described using the stereo cameras but the stereo cameras may not be necessarily used. The n cameras may not be composed only of the n/2 first cameras and the n/2 second cameras but may be composed of i first cameras and j second cameras.

### Others

The embodiment and its variations 1 and 2 have been described above where the plurality of cameras 100-1 to 100-n and 101-1 to 101-a are the fixed and unfixed cameras, respectively. The configuration is not limited thereto and all the cameras may be fixed cameras. The n images used in the three-dimensional modeling have been described as the images captured by the fixed cameras but may include images captured by the unfixed cameras.

While the free viewpoint video generation system according to the embodiment of the present disclosure has been described above, the present disclosure is not limited to this embodiment.

The processors included in the free viewpoint video generation system according to the embodiment described above are typically large-scale integrated (LSI) circuits. These processors may be individual chips or some or all of the processors may be included in a single chip.

The circuit integration is not limited to the LSI but may be implemented by dedicated circuits or a general-purpose processor. A field programmable gate array (FPGA) programable after manufacturing an LSI circuit or a reconfigurable processor capable of reconfiguring connections and setting of circuit cells inside the LSI circuit may be utilized.

In the embodiment and variations, the constituent elements may be implemented as dedicated hardware or executed by software programs suitable for the constituent elements. The constituent elements may be achieved by a program executor, such as a CPU or a processor, reading and executing software programs stored in a hard disk or a semiconductor memory.

The present disclosure may be implemented as various methods executed by the free viewpoint video generation system.

How to divide the blocks in the block diagrams are mere examples. The plurality of blocks may be implemented as a single block. One of the blocks may be divided into a plurality of blocks. Alternatively, some of the functions of a block may be transferred to another block. Similar functions of a plurality of blocks may be processed in parallel or in-timesharing by a single hardware or software unit.

The orders of executing the steps in the flowcharts are mere examples for specifically describing the present disclosure and may be any other order. Some of the steps may be executed simultaneously (i.e., in parallel) to another step.

The free viewpoint video generation system according to one or more aspects has been described based on the embodiment. The present disclosure is however not limited to this embodiment. The present disclosure may include other embodiments, such as those obtained by variously modifying the embodiment as conceived by those skilled in the art or those achieved by freely combining the constituent elements in the embodiment without departing from the scope and spirit of the present disclosure.

### INDUSTRIAL APPLICABILITY

The present disclosure is applicable to a free viewpoint video generation method and a free viewpoint video generation device. Specifically, the present disclosure is applicable to, for example, a three-dimensional spatial recognition system, a free viewpoint video generation system, and a next-generation monitoring system.

What is claimed is:

1. A method of generating a three-dimensional model, the method comprising:
calculating camera parameters of n cameras based on m first images, the m first images being captured from m different viewpoints by the n cameras, n being an integer greater than one, m being an integer greater than n; and
generating the three-dimensional model based on n second images and the camera parameters, the n second images being captured from n different viewpoints by the n cameras, respectively.

2. The method according to claim 1, wherein
the m first images are captured from the m different viewpoints by the n cameras and an additional camera, and
an additional camera parameter of the additional camera is calculated based on the m first images.

3. The method according to claim 1, further comprising:
generating a free viewpoint video based on (1) 1 third images respectively captured by 1 cameras included in the n cameras, where 1 is an integer greater than or equal to two and less than n, (2) the camera parameters calculated in the calculating, and (3) the three-dimensional model generated in the generating of the three-dimensional model.

4. The method according to claim 2, wherein
in the calculating, (1) first camera parameters that are camera parameters of a plurality of cameras including the n cameras and the additional camera are calculated based on the m first images captured by the plurality of cameras, and (2) second camera parameters that are the camera parameters of the n cameras are calculated based on the first camera parameters and n fourth images respectively captured by the n cameras, and
in the generating of the three-dimensional model, the three-dimensional model is generated based on the n second images and the second camera parameters.

5. The method according to claim 3, wherein
the n cameras include i first cameras that perform imaging with a first sensitivity, and j second cameras that perform imaging with a second sensitivity that is different from the first sensitivity,
in the generating of the three-dimensional model, the three-dimensional model is generated based on the n second images captured by all the n cameras, and
in the generating of the free viewpoint video, the free viewpoint video is generated based on the camera parameters, the three-dimensional model, and the 1 third images that are captured by the i first cameras or the j second cameras.

6. The method according to claim 5, wherein
the i first cameras and the j second cameras have color sensitivities different from each other.

7. The method according to claim 5, wherein
the i first cameras and the j second cameras have brightness sensitivities different from each other.

8. The method according to claim 2, wherein
the n cameras are fixed cameras fixed in positions and orientations different from each other, and
the additional camera is an unfixed camera that is not fixed.

9. The method according to claim 8, wherein
the m first images used in the calculating include images captured at different times, and
the n second images used in the generating of the three-dimensional model are images captured by the n cameras at a first time.

10. A device for generating a three-dimensional model, the device comprising:
a processor; and
a memory, wherein
using the memory, the processor
calculates camera parameters of n cameras based on m first images, the m first images being captured from m different viewpoints by the n cameras, n being an integer greater than one, m being an integer greater than n, and
generates the three-dimensional model based on n second images and the camera parameters, the n second images being captured from n different viewpoints by the n cameras, respectively.

11. A non-transitory storage medium storing a program for causing a computer to execute a method of generating a three-dimensional model, wherein
the method includes:
calculating camera parameters of n cameras based on m first images, the m first images being captured from m different viewpoints by the n cameras, n being an integer greater than one, m being an integer greater than n, and
generating the three-dimensional model based on n second images and the camera parameters, the n second images being captured from n different viewpoints by the n cameras, respectively.
